(19) United States
(12) Patent Application Publication
(10) Pub. No.: US 2021/0269672 A1
(43) Pub. Date: Sep. 2, 2021

(54) METHOD FOR DESULFURIZATION OF CRUDE SULFATE TURPENTINE

(71) Applicant: Stora Enso OYJ, Helsinki (FI)

(72) Inventors: Jari Kavakka, Espoo (FI); Staffan Torssell, Bromma (SE)

(73) Assignee: Stora Enso OYJ, Helsinki (FI)

(21) Appl. No.: 17/258,827

(22) PCT Filed: Jul. 8, 2019
(86) PCT No.: PCT/IB2019/055797

§ 371 Date: Jan. 8, 2021

(30) Foreign Application Priority Data
Jul. 10, 2018 (SE) 1850870-5

(51) Int. Cl. C09F 3/02; B01D 15/18; B01D 3/10; B01D 3/14; B01D 15/30; B01D 11/04; G01N 30/42

(52) U.S. Cl. CPC C09F 3/02; B01D 15/1807; B01D 3/10; B01D 3/143; G01N 30/42; B01D 11/0434; B01D 11/0438; B01D 15/1892; B01D 15/30

(57) ABSTRACT

A method for removing sulfur-containing compounds from crude sulfate turpentine (CST), said method comprising the step of: subjecting CST to continuous liquid-liquid extraction to remove sulfur-containing compounds.

### TECHNICAL FIELD

The present invention relates to methods for removal of sulfur containing impurities from crude sulfate turpentine (CST).

### BACKGROUND

Crude sulfate turpentine is obtained as a side product from softwood pulping. CST is mainly composed of terpenes like α-pinene, β-pinene, δ3-carene, camphene, dipentene, terpinolene and limonene.

Whereas turpentine originating from mechanical pulping and plywood process is sulfur free, turpentine obtained from the Kraft-process contains sulfur and organosulfur compounds as impurities. In CST, these malodorous sulfur-containing compounds include e.g. elemental sulfur, dimethyl sulfide (DMS), and dimethyl disulfide (DMDS). The CST also typically comprises low concentrations of water.

Turpentine yield depends on the process and feedstock used in the pulping. Typically, about 3 kg of CST can be isolated for each air-dry ton (Adt) of Kraft-pulp produced. Turpentine is a commercial product and it is sold mainly to distillers who fractionate it to sulfur free turpentine and/or to individual terpenes to be sold as fine chemicals. The major use of turpentine is as a raw material for the chemical industry. Terpenes and other compounds extracted from turpentine can be used for such products as tires, plastics, adhesives, flavors and fragrances, cosmetics, paints, and pharmaceuticals.

Currently, CST can be purified by oxidizing the sulfides to higher boiling compounds followed by fractional distillation. This approach produces unwanted waste and side products from the oxidation. Also, high number of theoretical plates in the distillation is needed to achieve the required sulfur-levels (typically <5 ppm sulfur) for commercial terpene products, making this method relatively expensive.

Therefore, there exists a need in the field for improved methods for desulfurization of crude sulfate turpentine.

### DESCRIPTION OF THE INVENTION

It is an object of the present disclosure to alleviate at least some of the disadvantages of current methods for purification and desulfurization of CST.

It is another object of the present disclosure to provide a method for desulfurization of CST which results in desulfurized CST or individual terpene fractions having reduced levels of sulfur and organosulfur compounds as impurities.

It is another object of the present disclosure to provide a method for desulfurization of CST which results in less or no unwanted oxidation side products and/or reduces the number of theoretical plates required in fractional distillation of the CST.

Other objects may be to obtain environmental, health and/or economic benefits of reduced emission of chemicals used in the prior art methods for oxidation of sulfides to higher boiling compounds.

According to a first aspect illustrated herein, there is provided a method for removing sulfur-containing compounds from crude sulfate turpentine (CST), said method comprising the step of subjecting CST to continuous liquid-liquid extraction (LLE) to remove sulfur-containing compounds.

Liquid-liquid extraction, also known as solvent extraction and partitioning, is a method to separate compounds based on their relative solubilities in two different immiscible liquids, usually a polar phase and an organic non-polar solvent.

According to the invention, a first way of subjecting CST to continuous liquid-liquid extraction is subjecting CST to centrifugal countercurrent chromatography (CCCC) to remove sulfur-containing compounds.

According to the invention, a second way of subjecting CST to continuous liquid-liquid extraction is subjecting CST to continuous liquid-liquid extraction using a vertical liquid-liquid extraction column to remove sulfur-containing compounds.

The inventive method, also referred to herein as the “desulfurization method”, allows for purification and desulfurization of CST resulting in desulfurized CST or individual terpene fractions having reduced levels of sulfur and organosulfur compounds as impurities, less or no unwanted oxidation side products, and/or a reduced number of theoretical plates required in fractional distillation of the CST.

The CST to be treated using the desulfurization method of the present disclosure is typically obtained from a Kraft pulping process. Turpentine is a mixture of constituents. CST is mainly composed of terpenes like α-pinene, β-pinene, δ3-carene, camphene, dipentene, terpinolene and limonene. The exact composition of CST may vary within wide ranges depending on the type of tree, the geographical location of the trees, pulping process parameters and process details, and the season of tree harvest. As an example, turpentine produced in the United States is typically made up primarily of (numbers obtained from “Toxicological Summary For Turpentine”, NIEHS, February 2002) α-pinene (40 to 70% by weight) with varying amounts of 13-pinene (15 to 35% by weight), camphene (1 to 2% by weight), limonene (5 to 10% by weight), and 3-carene (2-10% by weight). Turpentine produced in Sweden is typically made up primarily of α-pinene (50 to 70% by weight) with varying amounts of β-pinene (4 to 10% by weight), camphene (˜1% by weight), limonene (1 to 3% by weight), and 3-carene (15-40% by weight).

Turpentine obtained from the Kraft-process contains sulfur and organosulfur compounds as impurities. In CST, these malodorous sulfur-containing compounds include e.g. elemental sulfur, dimethyl sulfide (DMS), methyl mercaptan and dimethyl disulfide (DMDS). The CST also typically comprises low concentrations of water.

Countercurrent chromatography (CCC) encompasses a collection of related liquid chromatography techniques that employ two immiscible liquid phases without a solid support. The two liquid phases are brought in contact with each other as at least one of the phases is pumped through a column or a series of chambers containing both phases. One of the liquid phases is often used as a stationary phase that is held in place by gravity or centrifugal force.

CCC is used to separate, identify, and/or quantify the chemical components of a mixture. Separation in CCC is based on differences in compound distribution coefficient (K_{D}) in a biphasic solvent system. Dynamic mixing and settling allows the components to be separated by their respective solubilities in the two phases.

The recent developments of traditional countercurrent chromatography (CCC) with a centrifugal approach, so called “centrifugal force assisted countercurrent chromatography”, or simply “centrifugal countercurrent chromatography” (CCCC), is opening the possibility for large volume separations as well as broadening the possible solvent system space.

Some types of countercurrent chromatography, involve a true countercurrent process where the two immiscible phases flow past each other and exit at opposite ends of the column. In other types of countercurrent chromatography, one liquid acts as a stationary phase, which is retained in the column while a mobile phase is pumped through it.

In CCCC, the liquid stationary phase is held in place by centrifugal force. The two main modes by which the stationary phase is retained by centrifugal force are “hydrostatic” and “hydrodynamic”. In the hydrostatic method, often referred to as centrifugal partition chromatography (CPC), the column is typically rotated around a central axis. The hydrodynamic method, often referred to as high-speed or high-performance countercurrent chromatography (HSCCC and HPCCC), typically relies on the Archimedes screw force in a helical coil to retain the stationary phase in the column. Recent developments, particularly in HPCCC has created a viable option to existing liquid purification techniques like high-performance liquid chromatography (HPLC) and distillation.

The inventive method uses CCCC to remove sulfur-containing compounds from CST. The CCCC of the inventive method may for example be selected from the group consisting of centrifugal partition chromatography (CPC), high-performance countercurrent chromatography (HPCCC) and high-speed countercurrent chromatography (HSCCC). In some embodiments of the inventive method, the CCCC is selected from the group consisting of high-performance countercurrent chromatography (HPCCC) and high-speed countercurrent chromatography (HSCCC). In a preferred embodiment, the CCCC is HPCCC.

In a preferred embodiment, the CCCC is HPCCC. The operating principle of an HPCCC system requires a column consisting of a tube coiled around a bobbin. The bobbin is rotated in a double-axis gyratory motion (a cardioid), which causes a variable g-force to act on the column during each rotation. This motion causes the column to see one partitioning step per revolution and components of the sample separate in the column due to their partitioning coefficient between the two immiscible liquid phases. Development of instruments generating higher g-force and having larger bore of the column has enabled a great increase in throughput of HPCCC systems in recent years, due to improved mobile phase flow rates and a higher stationary phase retention.

The components of a CCC system are similar to most liquid chromatography configurations, such as high-performance liquid chromatography. One or more pumps may be used to deliver the phases to the column which is the CCC instrument itself. Samples may be introduced into the column through a sample loop. The outflow may be monitored with various detection methods, such as ultraviolet-visible spectroscopy or mass spectrometry. The operation of the pumps, the CCC instrument, sample injection, and detection may be controlled manually or with a microprocessor.

All CCC separation processes involve three main stages: mixing, settling, and separation of the two phases (although they often occur continuously). Vigorous mixing is important in order to maximize the interfacial area between the phases and facilitate mass transfer. The dissolved compounds will distribute between the phases according their distribution coefficients (K_{D}), also sometimes referred to as partition coefficient, distribution constant, or partition ratio and represented by P, K, D, or K_{C}.

CCC separation typically starts with choosing an appropriate biphasic solvent system for the desired separation. The two solvent phases are then fed from opposite ends of the column, brought into contact with each other, and each phase collected at the end of the column opposite to the end to which it was fed. The flow rate of the phases may be the same or different and can be adjusted in order to optimize the separation.

Typically, neither of the two phases will be entirely “stationary” as might be the case in a solid-state chromatography column. Instead, both phases will typically be subject to at least some degree of replacement and/or recirculation. In some cases, the replacement rate of the polar and non-polar phase may be of the same order of magnitude, whereas in other cases, the replacement rate of one phase may be much greater than the replacement rate of the other phase. In the latter case, the phase with the low replacement rate may be viewed as the “stationary” phase, and the phase with the high replacement rate may be viewed as the mobile phase. The term stationary phase, as used herein, is thus used to denote a phase with a relatively low replacement rate, as compared to a mobile phase with a relatively high replacement rate.

In the CCCC step of the present disclosure, the CST constitutes one of the two phases, and the other phase, also referred to herein as “the polar phase”, should be selected accordingly, i.e. a polar phase having low solubility for CST while having high solubility for sulfur or organosulfur impurities present in the CST.

Selection of suitable solvents may be guided by CCC literature, optionally combined with thin layer chromatography. A solvent system can be tested with a one-flask partitioning experiment. The measured partition coefficient from the partitioning experiment will indicate the elution behavior of the compound.

In some embodiments, the CCCC step is conducted by feeding CST and the polar phase from opposite ends of the column, bringing the two phases into contact with each other, and collecting each phase at the end of the column opposite to the end to which it was fed.

In some embodiments, the CCCC step is conducted using the CST as the mobile phase and a polar phase as the stationary phase.

In some embodiments, the CCCC step is conducted using the CST as the stationary phase and a polar phase as the mobile phase.

The polar phase may comprise a single solvent or a mixture of two or more solvents.

In some embodiments of the desulfurization method, the polar phase of the CCCC comprises a polar aprotic organosulfur solvent.

One solvent which has been found particularly useful as the polar phase of the CCCC step is sulfolane and mixtures thereof with another solvent, particularly mixtures of sulfolane and water. Sulfolane (also known as tetramethylene sulfone, or 2,3,4,5-tetrahydrothiophene-1,1-dioxide) is a colorless liquid organosulfur solvent, a cyclic sulfone, with the formula (CH₂)₄SO₂. Sulfolane is a polar aprotic solvent, and it is readily soluble in water. Sulfolane is also miscible with alcohols, acetone and toluene making them good candidates for co-solvents to sulfolane as the polar phase either with or without addition of water. Besides having been found to possess suitable solvent properties for removal of sulfur and organosulfur impurities from CST, sulfolane is also a commercially viable solvent since it is highly stable (i.e. resistant to degradation) and cost effective.

It has been found that sulfolane can be purified and recycled after extraction to be used in further CST purification according to the inventive procedure. Modeling has shown that it is possible to use the high boiling point of sulfolane to purify it. Water and DMDS can be evaporated from the sulfolane without having to evaporate the entire sulfolane stream using fairly low in energy consumption. The remaining sulfolane can thereafter be recycled to the extraction process without further purification.

Thus, in some embodiments of the desulfurization method the polar phase of the CCCC comprises sulfolane. In some embodiments, the polar phase of the CCCC consists of, or essentially consists of, sulfolane.

In some embodiments, the polar phase of the CCCC comprises a mixture of sulfolane and water. In some embodiments, the polar phase of the CCCC consists of, or essentially consists of, a mixture of sulfolane and water.

When the polar phase comprises a mixture of sulfolane and water, water is preferably present in an amount of 50% by volume or less, preferably 20% by volume or less, preferably 15% by volume, more preferably 10% by volume or less. In some embodiments, the polar phase comprises 0.1-50% by volume, preferably 1-20% by volume, preferably 1-10% by volume, more preferably 1-5% by volume, of water in sulfolane.

When the polar phase comprises a mixture of sulfolane and water and an organic co-solvent, water is preferably present in an amount of 50% by volume or less, preferably 20% by volume or less, preferably 15% by volume, more preferably 10% by volume or less. In some embodiments, the polar phase comprises 0.1-50% by volume, preferably 0.5-20% by volume, preferably 0.5-10% by volume, more preferably 0.5-5% by volume, of water in sulfolane and organic co-solvent. The organic co-solvent in the polar phase is preferably present in an amount of 50% by volume or less, preferably 20% by volume or less, preferably 15% by volume, more preferably 10% by volume or less.

The organic co-solvent present in the polar phase is selected from the group consisting of alcohols, ketones and aromatic hydrocarbons. In some embodiments the polar phase comprises 1-50% by volume, preferably 1-20% by volume, more preferably 1-10% by volume, of ethanol in sulfolane and water. In some embodiments the polar phase comprises 1-50% by volume, preferably 1-20% by volume, more preferably 1-10% by volume, of acetone in sulfolane and water. In some embodiments the polar phase comprises 1-50% by volume, preferably 10-50% by volume, more preferably 20-50% by volume, of toluene in sulfolane and water.

The CCCC step may advantageously be combined with a vacuum distillation step as an efficient means for removing certain fractions of sulfur-containing compounds from the CST. A vacuum distillation step is especially useful for removing low boiling sulfur-containing compounds. The vacuum distillation may be performed prior or subsequent to the CCCC step, or both prior and subsequent to the CCCC step.

The distillation may be performed continuously or as batch operation. A boiler is filled with CST and a vacuum is drawn whilst the CST is heated up to the point where the lightest compounds begin to boil off. This light fraction, often referred to as “heads” will contain mostly water and low boiling sulfur compounds. The vacuum distillation of the heads may optionally be followed by fractionation of the remaining higher boiling CST components, by increasing the temperature and vacuum. This way, individual pinenes could be separated and recovered. The difference in volatility between the alpha and beta forms is sufficient to permit quite good separation by distillation.

According to some embodiments, the desulfurization method further comprises the step of subjecting CST to vacuum distillation to remove low boiling sulfur-containing compounds, wherein the vacuum distillation step is performed prior or subsequent to the CCCC step. The boiling point range (at atmospheric pressure) of the distillate of the vacuum distillation is preferably in the range of 130-190° C., preferably in the range of 140-180° C., more preferably in the range of 150-170° C.

In some embodiments, the vacuum distillation step is performed prior to the CCCC step. Performing vacuum distillation prior to the CCCC step is preferred since a large portion of low boiling sulfur-containing compounds, e.g. dimethyl sulfide (DMS) can be efficiently removed, allowing for the capacity of the CCCC to be used for removal of higher boiling compounds like dimethyl disulfide, which are not as easily removed by distillation.

In some embodiments, the vacuum distillation step is performed subsequent to the CCCC step. Performing vacuum distillation subsequent to the CCCC step is sometimes preferred, as it allows for the simultaneous removal of remaining low boiling sulfur-containing compounds and fractionation of the CST to separate individual terpenes.

In some embodiments, the desulfurization method further comprises the step of subjecting the CST to fractional distillation to separate individual terpenes, wherein the fractional distillation step is performed subsequent to the CCCC step. In some embodiments, the vacuum distillation and fractional distillation are performed in a combined in distillation step. This way, individual sulfur free (or low sulfur) terpenes can be obtained with CCCC and a single distillation step.

In some embodiments, the sulfur-containing compounds include at least one of elemental sulfur, DMS and DMDS. Whereas low boiling compounds like DMS can be removed with reasonable efficiency using conventional methods like vacuum distillation, DMDS is more difficult to remove to an acceptable level without using a very high number of theoretical plates in the distillation. CCCC provides for efficient removal of dimethyl disulfide from the CST to very low levels.

A method according to any one of the preceding claims, wherein the CST after being subjected to CCCC, and optionally vacuum distillation, has a sulfur level of less than 20 ppm, preferably less than 10 ppm, more preferably less than 5 ppm.

As mentioned above, a second way of subjecting CST to continuous liquid-liquid extraction is by continuous liquid-liquid extraction using a vertical liquid-liquid extraction column to remove sulfur-containing compounds.

Said vertical liquid-liquid extraction column is preferably selected from the group consisting of packed or tray-containing columns or mechanically agitated extractors, wherein the mechanically agitated extractor is selected from the group consisting of rotary-agitated columns or reciprocating or vibrating columns.

The above described aspects with regards to the polar phase and suitable solvents also apply to the use of a vertical liquid-liquid extraction column.

After having been subjected to liquid-liquid extraction, the CST has a dimethyl disulfide level of less than 20 ppm, preferably less than 10 ppm, more preferably less than 5 ppm.

The inventor has surprisingly found that continuous liquid-liquid extraction such as CCCC or vertical liquid-liquid extraction column can be used as a viable alternative to previous solutions for CTS desulfurization. The use of e.g. CCCC allows for purification and desulfurization of CST resulting in desulfurized CST or individual terpene fractions having reduced levels sulfur and organosulfur compounds as impurities, less or no unwanted oxidation side products, and/or a reduced number of theoretical plates required in fractional distillation of the CST. The use of CCCC may also offer additional advantages, including environmental, health and/or economic benefits of reduced emission of chemicals used in the prior art methods for oxidation of sulfides to higher boiling compounds.

Thus, according to a second aspect illustrated herein, there is provided the use of continuous liquid-liquid extraction to remove sulfur-containing compounds from crude sulfate turpentine (CST).

According to a first use illustrated herein, there is provided the use of centrifugal countercurrent chromatography (CCCC) for removing sulfur-containing compounds from crude sulfate turpentine (CST).

Furthermore, according to a second use illustrated herein, there is provided the use of vertical liquid-liquid extraction column for removing sulfur-containing compounds from crude sulfate turpentine (CST).

The first and second use referred to above may be further defined as set out above with reference to the method of the first aspect.

Particularly, in the case of the inventive first use, the CCCC may be selected from the group consisting of centrifugal partition chromatography (CPC), high-performance countercurrent chromatography (HPCCC) and high-speed countercurrent chromatography (HSCCC). In some embodiments of the inventive use, the CCCC is selected from the group consisting of high-performance countercurrent chromatography (HPCCC) and high-speed countercurrent chromatography (HSCCC). In a preferred embodiment, the CCCC is HPCCC.

Particularly, in the case of the inventive second use, the liquid-liquid extraction column is preferably selected from the group consisting of packed or tray-containing columns or mechanically agitated extractors, wherein the mechanically agitated extractor is selected from the group consisting of rotary-agitated columns or reciprocating or vibrating columns.

Also, the CST product obtained from a desulfurization method according to the present disclosure may have advantages as compared to CST products obtained using prior art desulfurization methods. As an example, the CST product obtained from a desulfurization method according to the present disclosure will not comprise unwanted oxidation residues or byproducts to the same extent as CST products obtained using oxidation-based desulfurization methods.

Thus, according to a further aspect illustrated herein, there is provided crude sulfate turpentine (CST), obtained by a desulfurization method as described herein with reference to the first and second aspect.

According to some embodiments, the crude sulfate turpentine (CST), obtained by a desulfurization method of the present disclosure has a sulfur level of less than 20 ppm, preferably less than 10 ppm, more preferably less than 5 ppm.

While the invention has been described with reference to various exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLE 1

### Extraction of CST with Sulfolane Containing 0-30% Water

2 ml crude sulfate turpentine (CST, composition as set out in Table 1-1) was extracted in a glass extraction funnel with an equal volume of sulfolane (99%, obtained from Alfa Aesar) containing 0-30% water as set out in Table 2.

TABLE 1-1

| Compound | wt % |
|---|---|
| α-Pinene | 57.5 |
| β-Pinene | 4.6 |
| Carene | 16.1 |
| Limonene | 4.2 |
| Camphene | 0.8 |
| α-Terpineol | 1.8 |
| Dipentene | 1.0 |
| β-phellandrene | 0.2 |
| Myrcene | 0.8 |
| Pine oil | 3.1 |
| Anethole | 0.2 |
| Sesquiterpene | 3.6 |
| Light org. | 2.2 |
| Water | 1.0 |
| Sulfur | 1.8 |
| Other | 1.2 |

After mixing and settling in ambient temperature, the distribution coefficients where determined by measuring the content of the respective compounds in the two phases by GC-TQ (gas chromatography—triple quadrupole mass spectrometry) using 1-fluoronaphthalene as an internal standard. The results are presented in Table 1-2. Also, 0.6-0.7% of sulfolane was detected in the upper CST phase.

TABLE 1-2

| Water in | K_{D} | | |
|---|---|---|---|
| sulfolane (%) | DMDS | α-Pinene | Sulfolane |
| 0 | 2.2 | 43 | — |
| 1 | 0.9 | 20 | 0.006 |
| 5 | 1.4 | 56 | 0.005 |
| 10 | 1.9 | 36 | 0.005 |
| 20 | 3.5 | 189 | 0.04 |
| 30 | 5.6 | 141 | 0.007 |

### EXAMPLE 2

### Extraction of CST with Sulfolane Containing Water and/or Additional Solvents

The extraction experiments were conducted according to Example 1 and the two solvent phases were analyzed using GC-MS and the results are summarized in Table 2.

TABLE 2

| | K_{D} | | |
|---|---|---|---|
| 2-Phase systems | DMDS | α-Pinene | Sulfolane |
| Sulfolane (1% H2O)/EtOH/CST: | 0.85 | 15 | 0.009 |
| 45/5/50 | | | |
| Sulfolane (5% H2O)/EtOH/CST: | 1.2 | 28 | 0.01 |
| 45/10/45 | | | |
| Sulfolane (5% H2O)/EtOH/CST: | 1.0 | 16 | 0.006 |
| 45/5/50 | | | |
| Sulfolane (1% EtOH)/CST: | 0.9 | 14 | 0.01 |
| 50/50 | | | |
| Sulfolane (5% H2O)/BuOH/CST: | 1.1 | 20 | 0.009 |
| 45/5/50 | | | |
| Sulfolane (5% H2O)/Acetone/CST: | 1.1 | 22 | 0.008 |
| 45/5/50 | | | |
| Sulfolane (5% H2O)/Toluene/CST: | 1.6 | 36 | 0.01 |
| 45/10/45 | | | |
| Sulfolane (5% H2O)/Toluene/CST: | 1.4 | 43 | 0.03 |
| 40/20/40 | | | |
| Sulfolane (5% H2O)/Toluene/CST: | 1.5 | 16 | 0.003 |
| 30/30/40 | | | |
| Sulfolane (10% H2O)/Toluene/CST: | 2.3 | 36 | 0.03 |
| 30/30/40 | | | |

### EXAMPLE 4

### Purification of CST Using CPC Separation with Sulfolane Containing 5% Water

For this separation trial a Centrifugal Partition Chromatography (CPC) instrument from Kromaton was used with a 200 mL stationary phase rotor. The stationary phase rotor (200 mL) was filled with sulfolane containing 5% water. CST was then pumped through the CPC-instrument at different flow rates (5 and 8 mL/min) and the out-going purified CST stream was collected in 20 mL fractions. After the trial was completed the collected CST fractions (Table 4-1) and the stationary phase sulfolane (Table 4-2) were analyzed by GC-MS to determine DMDS, α-pinene and sulfolane content in different samples.

TABLE 4-1
purified CST fractions.

Flow (mL/min)

| | | | |
|---|---|---|---|
| 8 | 5 | 8 | 5 |

| | | |
|---|---|---|
| Fractions (20 mL) | DMDS (ppm) | Sulfolane (ppm) |

| | | | | |
|---|---|---|---|---|
| 1 | <5 | 22 | 3305 | 4227 |
| 2 | <5 | 4 | 3130 | 5312 |
| 3 | <5 | 6 | 3602 | 5593 |
| 4 | 182 | 27 | 3731 | 6099 |
| 5 | ND | 16 | ND | 4743 |
| 6 | 750 | 91 | 3755 | 6393 |
| 7 | ND | 144 | ND | 6755 |
| 8 | 918 | 138 | 5125 | 8949 |
| 9 | 950 | — | 5961 | — |

DMDS in CST: 1200 ppm.
α-Pinene in CST: 220500 ppm

TABLE 4-2
stationary phase.

Flow (mL/min)

| | | | |
|---|---|---|---|
| 8 | 5 | 8 | 5 |

| | | |
|---|---|---|
| Compound | DMDS (ppm) | α-Pinene (ppm) |

| | | | | |
|---|---|---|---|---|
| Stationary phase | 652 | 925 | N/D | 1183 |
| (200 mL) | | | | |

### EXAMPLE 5

### Purification of CST Using CPC Separation with Sulfolane Containing 1% Water

The same setup as in Example 4 was used for this trial.

The stationary phase rotor (200 mL) was filled with sulfolane containing 1% water. CST was then pumped through the CPC-instrument at 10 mL/min and the out-going purified CST stream was collected in 20 mL fractions. After the trial was completed the collected CST fractions (Table 5-1) and the stationary phase sulfolane (Table 5-2) were analyzed by GC-MS to determine DMDS, a-pinene and sulfolane content in different samples.

TABLE 5-1
purified CST fractions.

| Fractions (20 mL) | DMDS (ppm) | Sulfolane (ppm) |
|---|---|---|
| 1 | <5 | 4336 |
| 2 | <5 | 2763 |
| 3 | 5 | 5020 |
| 4 | <5 | 5803 |
| 5 | <5 | 5825 |
| 6 | <5 | 6228 |
| 7 | 74 | 6409 |
| 8 | 363 | 7449 |
| 9 | 854 | 6409 |

DMDS in CST: 1200 ppm.
α-Pinene in CST: 220500 ppm

TABLE 5-2
stationary sulfolane phase.

| Compound | DMDS (ppm) | α-Pinene (ppm) |
|---|---|---|
| Stationary phase | 925 | 11724 |
| (200 mL) | | |

### EXAMPLE 6

### Purification of CST Using CPC Separation with Sulfolane Containing 1% Water and 5% Ethanol

The same setup as in Example 4 was used for this trial.

The stationary phase rotor (200 mL) was filled with sulfolane containing 1% water and 5% EtOH. CST was then pumped through the CPC-instrument at 3 mL/min and the out-going purified CST stream was collected in 20 mL fractions. After the trial was completed the collected CST fractions (Table 6-1) and the stationary phase sulfolane (Table 6-2) were analyzed by GC-MS to determine DMDS, α-pinene and sulfolane content in different samples.

TABLE 6-1
purified CST fractions.

| Fractions (20 mL) | DMDS (ppm) | Sulfolane (ppm) |
|---|---|---|
| 1 | 10 | 5500 |
| 2 | 25 | 6095 |
| 3 | 7 | 6434 |
| 4 | 10 | 6477 |
| 5 | 8 | 6750 |
| 6 | 45 | 7214 |
| 7 | 178 | 7782 |
| 8 | 371 | 8712 |
| 9 | 608 | 10101 |
| 10 | 738 | 11938 |

DMDS in CST: 1200 ppm.
α-Pinene in CST: 220500 ppm

TABLE 6-2
stationary sulfolane phase.

| Compound | DMDS (ppm) | α-Pinene (ppm) |
|---|---|---|
| Stationary phase | 652 | 4929 |
| (200 mL) | | |

### EXAMPLE 7

### Purification of CST Using a Continuous Counter-Current Liquid-Liquid Extraction Column with Sulfolane Containing 1% Water

For this separation trial, a 1 m long and 15 mm ID vertical KARR-type, liquid-liquid extraction column was used were sulfolane (heavy phase) is pumped in from the top and CST (light phase) is pumped in at the bottom.

An equal flow relationship of 1:1 was used for the solvent phases CST and sulfolane+1% H2O, and a flow rate at 5 mL/min applied. A phase flow equilibrium was reached after ˜2 residence times (40 minutes run time) and samples of both solvent phases were withdrawn as well as after ˜4 residence times (70 minutes run time), to be analyzed by GC-MS. The DMDS levels reached ca 200 ppm and 150 ppm in the ˜2 residence times sample and in the ˜4 residence times sample, respectively (Table 7). Ca 90% of the DMDS content in the CST was being extracted away by the sulfolane solvent phase.

TABLE 7
Counter-current extraction CST:Sulfolane (1% H2O) 1:1

| Sampled | DMDS | α-Pinene | Sulfolane |
|---|---|---|---|
| phases | (ppm) | (ppm) | (ppm) |
| CST, ~2 res time | 199 | 225330 | 5392 |
| CST, ~4 res time | 149 | 228423 | 5461 |
| Sulfolane, ~2 res time | 1098 | 14581 | 1208319 |
| Sulfolane, ~4 res time | 1040 | 13556 | 1132725 |
| Mass balance, ~2 res time | 108% | 109% | 102% |
| Mass balance, ~4 res time | 99% | 110% | 96% |

DMDS in CST: 1200 ppm
α-Pinene in CST: 220500 ppm
Sulfolane in Sulfolane + 1% H2O: 1190500 ppm

### EXAMPLE 8

### Purification of CST Using a Continuous Counter-Current Liquid-Liquid Extraction Column with Sulfolane Containing 1% water

The same column as in Example 7 was used.

In this trial a flow relationship of 1:2.5 was used for the solvent phases CST and sulfolane+1% H2O, and the same overall flow rate as in Example 6, 5 mL/min, was applied. A phase flow equilibrium was reached after ˜2 residence times (40 minutes run time) and samples of both solvent phases were withdrawn as well as after ˜4 residence times (70 minutes run time), to be analyzed by GC-MS. The DMDS levels in the eluted CST samples were 11 ppm and 8 ppm in the ˜2 and ˜4 residence times samples, respectively (Table 8).

TABLE 8
Counter-current extraction CST:Sulfolane (1% H2O) 1:2.5

| Sampled | DMDS | α-Pinene | Sulfolane |
|---|---|---|---|
| phases | (ppm) | (ppm) | (ppm) |
| CST, ~2 res time | 11 | 214301 | 4229 |
| CST, ~4 res time | 8 | 217499 | 4764 |
| Sulfolane, ~2 res time | 394 | 12210 | 899757 |
| Sulfolane, ~4 res time | 389 | 12209 | 902770 |
| Mass balance, ~2 res time | 83% | 111% | 76% |
| Mass balance, ~4 res time | 82% | 112% | 76% |

DMDS in CST: 1200 ppm
α-Pinene in CST: 220500 ppm
Sulfolane in Sulfolane + 1% H2O: 1190500 ppm

1. A method for removing sulfur-containing compounds from crude sulfate turpentine (CST), said method comprising the step of:
subjecting CST to a continuous liquid-liquid extraction to remove the sulfur-containing compounds from the CST.

2. The method according to claim 1 comprising the step of:
subjecting the CST to a centrifugal countercurrent chromatography (CCCC) to remove the sulfur-containing compounds.

3. The method according to claim 2, further comprising the step of:
subjecting the CST to a vacuum distillation to remove low boiling sulfur-containing compounds, wherein the vacuum distillation step is performed prior or subsequent to the CCCC step.

4. The method according to claim 3, wherein the vacuum distillation step is performed prior to the CCCC step.

5. The method according to claim 3, wherein the vacuum distillation step is performed subsequent to the CCCC step.

6. The method according to claim 2, further comprising the step of:
subjecting the CST to a fractional distillation to separate individual terpenes, wherein the fractional distillation step is performed subsequent to the CCCC step.

7. The method according to claim 6, wherein the vacuum distillation and the fractional distillation are performed in a combined in distillation step.

8. The method according to claim 2, wherein the CCCC is selected from a group consisting of: centrifugal partition chromatography (CPC), high-performance countercurrent chromatography (HPCCC) and high-speed countercurrent chromatography (HSCCC).

9. The method according to claim 2, wherein a polar phase of the CCCC comprises a polar aprotic organosulfur solvent.

10. The method according to claim 2, wherein a polar phase of the CCCC comprises sulfolane.

11. The method according to claim 2, wherein a polar phase of the CCCC comprises a mixture of sulfolane and water.

12. The method according to claim 2, wherein a polar phase of the CCCC comprises a mixture of sulfolane and a second solvent selected from a group consisting of: an alcohol, a ketone, an aromatic hydrocarbon, and water.

13. The method according to claim 2, wherein a polar phase of the CCCC comprises a mixture of sulfolane and ethanol.

14. The method according to claim 2, wherein a polar phase of the CCCC comprises a mixture of sulfolane, ethanol, and water.

15. The method according to claim 2, wherein a polar phase of the CCCC comprises a mixture of sulfolane, acetone, and water.

16. The method according to claim 2, wherein a polar phase of the CCCC comprises a mixture of sulfolane, toluene, and water.

17. The method according to claim 1, wherein the CST is obtained from a Kraft pulping process.

18. The method according to claim 1, wherein the sulfur-containing compounds include at least one of elemental sulfur, dimethyl sulfide, and dimethyl disulfide.

19. The method according to claim 2, wherein the CST, after being subjected to CCCC, has a sulfur level of less than 20 ppm.

20. The method according to claim 2, wherein the CST after being subjected to CCCC, has a dimethyl disulfide level of less than 20 ppm.

21. The method according to claim 3, wherein a boiling point range (at atmospheric pressure) of a distillate of the vacuum distillation is between 150-170° C.

22. (canceled)

23. The method according to claim 1, comprising the step of:
subjecting the CST to a continuous liquid-liquid extraction using a vertical liquid-liquid extraction column to remove the sulfur-containing compounds.

24. The method according to claim 23, wherein the liquid-liquid extraction column is selected from a group consisting of: a packed column, a tray-containing column, or a mechanically agitated extractors.

25. The method according to claim 24, wherein the mechanically agitated extractor is selected from a group consisting of: a rotary-agitated columns, a reciprocating column, or a vibrating columns.

26. The method according to claim 23, wherein the CST, after being subjected to liquid-liquid extraction, has a dimethyl disulfide level of less than 20 ppm.

27. (canceled)

28. The method according to claim 10, wherein the sulfolane exiting the extraction process is purified through evaporation of water and/or ethanol and extracted sulfur-containing products from the sulfolane.

29. The method according to claim 28, wherein the purified sulfolane is recycled to the extraction process without further purification.

30. A crude sulfate turpentine (CST), obtained by the method according to claim 1.
